(19) United States
(12) Patent Application Publication
(10) Pub. No.: US 2017/0322732 A1
(43) Pub. Date: Nov. 9, 2017

(54) COMPUTER SYSTEMS AND METHODS FOR IMPLEMENTING IN-MEMORY DATA STRUCTURES

(71) Applicant: Nasdaq Technology AB, Stockholm (SE)

(72) Inventors: Anton LISSONE, Son en Breugel (NL); Carst VAN DEN BOSCH, Oisterwijk (NL)

(21) Appl. No.: 15/584,113

(22) Filed: May 2, 2017

Related U.S. Application Data
(60) Provisional application No. 62/331,720, filed on May 4, 2016.

(51) Int. Cl. G06F 3/06

(52) U.S. Cl. CPC G06F 3/064; G06F 3/061; G06F 3/0673

(57) ABSTRACT

The technology relates to systems and methods for automatically determining, using an in-memory hierarchical data structure and traversal technique, the applicability of one or more sets of requirements for entities such as systems, processes, products, etc. Example embodiments represent selected sets of requirements in the in-memory hierarchical data structure based on which model objects representing various entities are evaluated.

### CROSS REFERENCE(S) TO RELATED APPLICATION(S)

This application claims the benefit of U.S. Patent Application No. 62/331,720 filed May 4, 2016, the entire contents of which are incorporated herein by reference.

### TECHNICAL OVERVIEW

The technology described herein relates to data structures and more particularly to in-memory data structures and processing systems that use in-memory data structures to satisfy one or more constraints.

### INTRODUCTION

Data structures organize data in a particular way to allow computers to efficiently work with, access, and/or use the information contained in the data structure. Different data structures include arrays, linked lists, trees, and classes, and the like, and they all have different strengths and weakness. Some data structures are efficient in helping a computer find a piece of information within the data structure, some are good for adding information to the data structure, some may be may be good for efficiently sorting the information, some may be easier for application developers to work with, and some data structures are developed with a specific application or type of application in mind.

Certain types of applications can lend themselves to certain types of data structures. This is because the needs of those applications (e.g., being able to efficiently retrieve information from a large data set) can be matched to the performance characteristics of a particular data structure type. However, developing new software applications with specific requirements often times presents new and interesting challenges for how the data for such applications should be formatted, stored, updated, accessed, and the like. Thus, it will be appreciated that new and useful techniques in these technical areas are continually sought after.

### SUMMARY

The technology in this application provides a particular data structure and a way for a computer system to efficiently traverse the data structure that efficiently implements, maintains, and applies policies as well as permits modifications and updates. The technology described in this document relates to systems and methods for receiving at an interface associated with a computer processor electronic user input corresponding to a document that defines a set of requirements. A memory stores an in-memory data structure having a set of nodes linked as a hierarchy. A highest level node in the hierarchy is mapped to the document, and other nodes at multiple lower levels in the hierarchy are mapped to parts of the document corresponding to different ones of the obligations or objectives in the set of requirements. Also stored in memory are: (i) a set of conditional rules, where when a specified condition is true, a specified determination is made and/or an action is performed, and (ii) a rule matrix that indicates a mapping of nodes to associated rules. Each node may have a node identifier representing the node's location in the hierarchy, and each rule may be associated with a rule identifier.

The interface associated with the computer processor receives electronic data corresponding to an event related to an object representing an entity such as a system, a process, a product, etc., or a change to one or more policies or rules. For each node of a plurality of nodes in the hierarchy of the in-memory tree data structure, the computer processor accesses the rule matrix to determine one or more rules associated with the node, and evaluates whether the determined one or more rules associated with the node applies to the model object. When the associated one or more rules associated with the node apply to the model object, the computer processor may perform a predetermined action for the model object. One of the actions may be to store the result of the evaluation.

In example embodiments, the computer processor performs the access and evaluation for the plurality of nodes to determine whether the selected object complies with the requirement(s) at applicable nodes of the in-memory data structure.

The features described herein may be combined to form additional embodiments and sub-elements of certain embodiments may form yet further embodiments. This summary is provided to introduce a selection of concepts in a simplified form that are further described below in the detailed description. This summary is intended neither to identify key features or essential features of the claimed subject matter, nor to be used to limit the scope of the claimed subject matter; rather, this summary is intended to provide an overview of the subject matter described in this document. Accordingly, it will be appreciated that the above-described features are merely examples, and that other features, aspects, and advantages of the subject matter described herein will become apparent from the following detailed description, figures, and claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is a block diagram of a computer-implemented system with in-memory data structures and computer-implemented rules for automatically applying policies to an object;

FIG. 2 shows a non-limiting example flowchart for applying an in-memory tree data structure to a model object using the computer-implemented system of FIG. 1;

FIG. 3 shows a non-limiting, example, networked hardware system for implementing the computer-implemented system and flowchart shown in FIGS. 1 and 2, respectively;

FIG. 4 is a block diagram of a non-limiting detailed example applying an in-memory information technology (IT) tree data structure and associated rules to application objects; and

FIG. 5 is an example computer system according to certain example embodiments that may be used as the computer system at a computer device referred to in the FIGS. 1-4 examples.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### Overview

As noted in the Introduction, the technology described in this document relates to data structures that organize data in a particular way to allow computers to efficiently work with, access, and/or use the information contained in the data structure. A computer system having an in-memory hierarchical node data structure advantageously manages, for example, policy rules and regulations for planning, organizing, staffing, leading, directing, and controlling an organization to accomplish one or more goals. Policies may be necessary because of contracts, service level agreements (SLAs), regulations, compliance or other standards, legal requirements, business objectives, etc. The individual topics and sub-topics of the policy document, file, or other semantic (referred to herein for convenience as a policy document) defining the policy are parsed and mapped to corresponding nodes in the in-memory hierarchical node data structure.

In certain example embodiments, a computer system is programmed to store a plurality of actions in a data structure. These actions relate to requirements or policies that may be applied to resources. The computer system is also programmed to accept or receive events related to the resources and efficiently evaluate the actions stored in the data structure to determine which ones of the stored actions should be implemented, applied, or triggered for one or more of the resources.

As an example, a computer system may be programmed to receive events each time a build for a software program (e.g., a resource) is set to be released. The computer system may store many different actions or policies (e.g., some that potentially relate to newly released software applications and others that do not). Upon reception of the release event, the system may traverse the stored policies to determine which ones should be applied before the software program is deployed on a production system. The techniques described herein may thus allow the computer system to efficiently perform such actions—even in complex environments with large numbers of stored policies, events, and/or resources.

The technology takes as inputs many new and different events that may affect the policy and uses the in-memory hierarchical data structure to determine what specific parts of the policy apply. Actions that may need to be taken for each new event to satisfy a level of compliance and/or rectify compliance deficiencies with respect to the policy may also be identified and/or implemented.

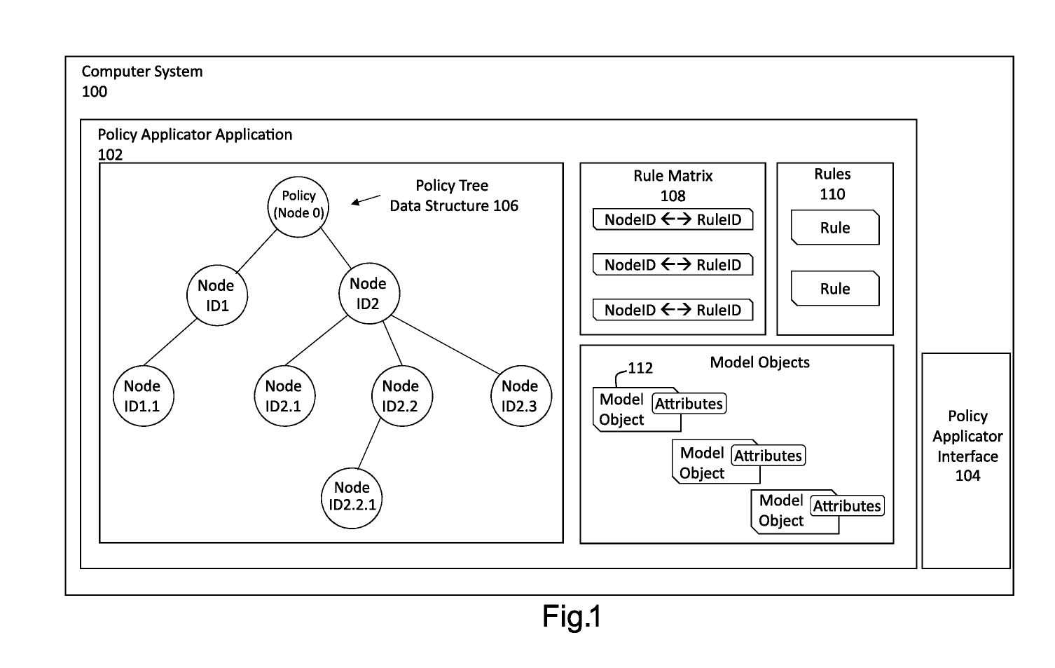

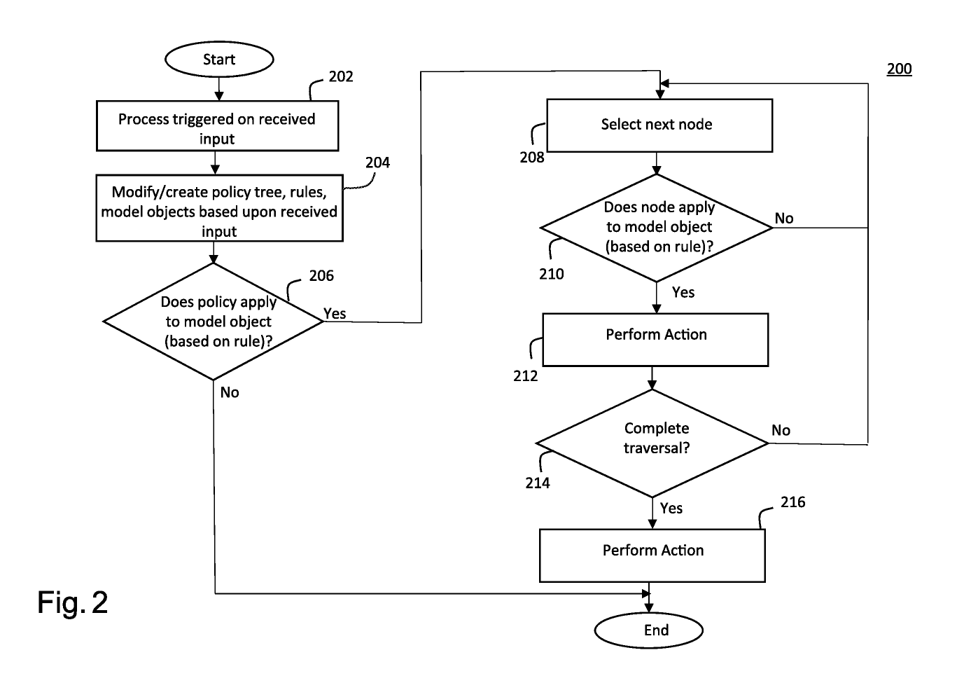

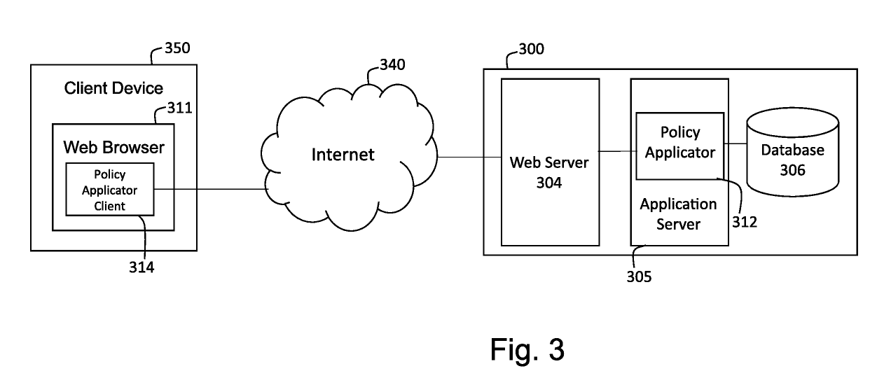

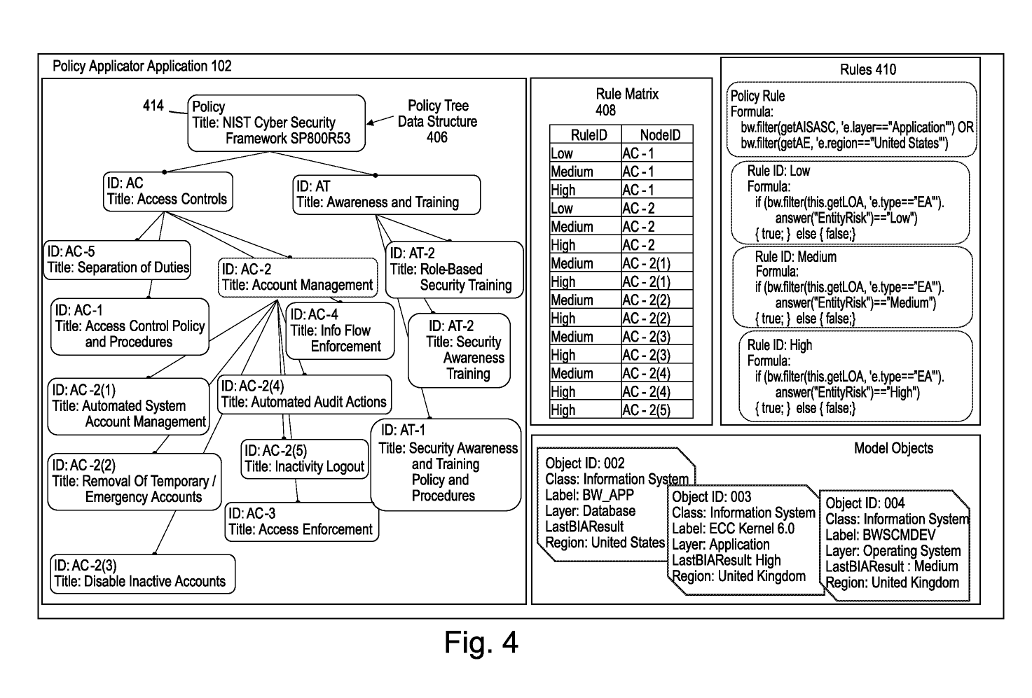

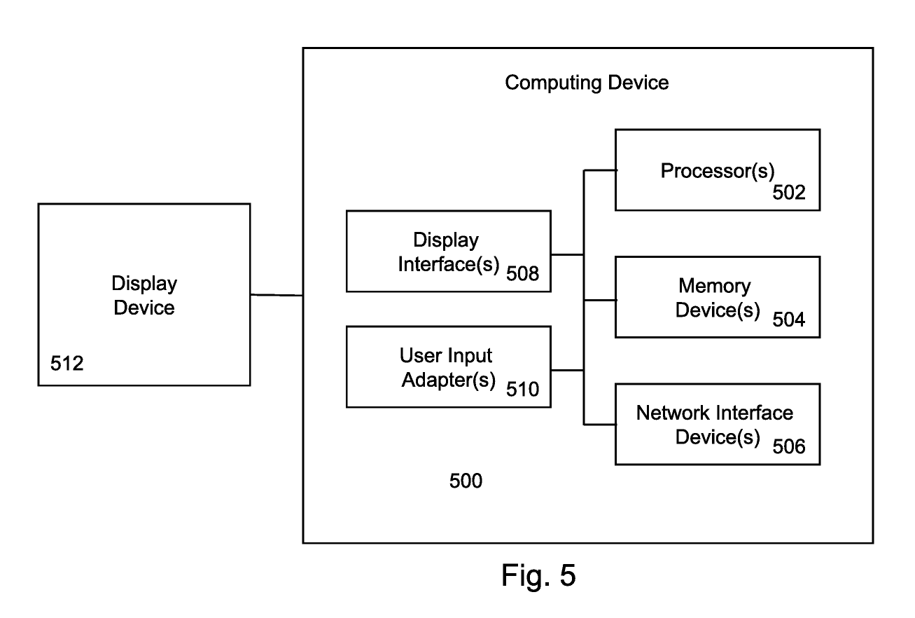

FIG. 1 is a block diagram of a computer-implemented system with in-memory data structures and computer-implemented rules for automatically applying policies to a new object, a new attribute of an existing object, and/or a change in an attribute of an existing object. FIG. 2 shows a non-limiting example flowchart for applying a policy data structure to a new object, a new attribute of an existing object, and/or a change in an attribute of an existing object using the computer-implemented system of FIG. 1. FIG. 3 shows a non-limiting example networked hardware system for implementing the computer-implemented system and flowchart shown in FIGS. 1 and 2, respectively. FIG. 4 is a block diagram of a non-limiting detailed example applying an information technology (IT) policy data structure and associated rules to application objects. FIG. 5 is an example computer system according to certain example embodiments that may be used as the computer system at a client and/or server device referred to in the FIGS. 1-4 examples.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

### FIG. 1

FIG. 1 is a block diagram of a computer-implemented system according to one or more example embodiments. A computer system 100 includes a policy applicator application 102 and a policy applicator interface 104 in the memory of the computer system 100. The policy applicator application 102 includes a policy document represented in a tree data structure 106. The tree data structure 106 includes multiple logical nodes coupled by various reference links to form a hierarchy of nodes. Each node is assigned a corresponding node identifier commensurate with its location in the hierarchy. The reference links between the nodes are parent-child links and may be implemented as pointers or other memory addressing mechanism. For example, parent node 0 (i.e. root node) is linked to (points to) its children nodes 1 and 2 at the next level down the hierarchy. Child node 1 is a leaf node without any children of its own. On the other hand, child node 2 is also a parent node to child nodes 2.1, 2.2, and 2.3 on the next level down the hierarchy. Child node 2.2.1 is on the fourth level of the hierarchy with a link to its parent node 2.2. In practice, there may be many more nodes in each level of the hierarchy and many more levels in the hierarchy. Persons skilled in the art will understand that some embodiments may represent the policy document in other forms of hierarchical data structures different from a tree data structure. It will also be understood that, in some embodiments, the node identifier of a node may not necessarily be commensurate with the location of that node in the hierarchy.

Initially, the policy tree data structure is generated from a policy document. For example, upon receiving a policy document in the form of a digital file, the policy applicator 102 may automatically create a node for each chapter, section and/or subsection of the document. Each node is then associated with parent-child relationships in accordance with the corresponding chapter, section and/or subsection relationships with one or more other nodes to form a hierarchy or tree. The root of the tree may represent the entire policy document. For example, in the policy tree data structure 106, a selected policy document may correspond to the policy node 0, chapters 1 and 2 to nodes 1 and 2, a topic addressed in chapter 1 to node 1.1, sub-chapters of chapter 2 to nodes 2.1-2.3, and a topic of sub-chapter 2.2 to node 2.2.1. In some embodiments, the hierarchy representing an input policy document may be, at least in part, generated and/or modified manually.

The memory also stores a rule matrix 108, where each node identifier is mapped to one or more rule identifiers. A rule may be mapped to one or more node identifiers. Rules 110 are implemented as computer instructions or logic statements and are often conditional type rules of the if-then format. If a rule's condition is met, then a specified action or determination is caused to be taken/made. In some example embodiments, a mapping other than a matrix may be used to represent the relationship between rules and nodes. For example, each node may include a pointer to, or may store as attributes, one or more rules associated with the node.

The computer memory further stores objects, referred to here as “model objects”. Each model object 112 has one or more attributes and one or more methods. A model object may be a single standalone object or complex object. For example, in an embodiment, an information system may be represented by a first model object which is a complex object, and each one of a plurality of subsystems of the information system can be represented by respective second model objects which are objects that are child objects of the complex first model object.

Each model object represents a system, process, product or other entity which is intended to be evaluated against one or more policies, using the computer system 100. In some embodiments, a model object may be formed as an instance of a class or the like in an object-oriented programming system using a development framework such as Python, C++, Java, Perl, Ruby, and the like. A model object may be either automatically generated from the entity that it represents, or may be manually created. For example, with respect to an object-oriented information system, the actual object defining the information system may be used in automatically generating a corresponding object as a model object. In some embodiments, the model object may be a bare-bones representation of the actual information system object, for example, in which only the child objects and relations with other objects are included as attributes.

A model object may also identify the entity which it represents. Additionally, a model object may include attributes which specify evaluation criteria and a rating associated with each evaluation criteria. The evaluation criteria and the associated ratings with respect to each evaluation criteria may be subsequently used when selecting applicable policy rules using the policy tree data structure 106. For example, in some embodiments, evaluation criteria, (e.g., confidentiality, integrity, availability, and/or one or more ratings based upon an impact of the entity on the system on one or more of those evaluation criteria), may be specified as Low, Medium, or High. The corresponding model objects may then be applied against nodes which may specify the relevance of the associated policy requirements and obligations in terms of each of those evaluation criteria as Low, Medium, or High.

The policy applicator interface 104 provides an input/output interface for policy applicator application 102. Interface 102 accepts user input and other inputs to configure the policy applicator application 104. User input may be provided by a keyboard, mouse and/or other user input device. Inputs from other sources may include inputs received, for example, from other applications processes and/or electronically stored data, program code, or specifications.

Consider the Following Examples where a Policy Applicator Application is Useful.

Various entities have obligations and objectives that must be implemented many times and in different instances, contexts, or situations. Failure to meet obligations and objectives presents issues such as financial issues (e.g., the price of oil spiking), environmental issues (how to respond to a tornado warning), accidents (a misrouted sales purchase), deliberate attacks (a computer security breach), legal issues (complying with various taxes, regulations, and laws), and governance and compliance issues. Together these are referred to as governance, risk management, and compliance (GRC). Monitoring, compliance, and management of obligations and objectives in different instances, contexts, or situations is complex and can be on a very large scale which presents significant challenges to manual and ad hoc processes with no or insufficient preset structure. For example, an organization may be presented with one or more documents that define different obligations and/or objectives such as contracts (e.g., service level agreements (SLAs)), regulations, standards, laws, business plans, and the like. These complexities and challenges are met by modeling a policy document with the in-memory data structures and computer-implemented rules for automatically applying policies to a new object, a new attribute of an existing object, and/or a change in an attribute of an existing object described with respect to FIG. 1 and now further described with reference to FIGS. 2-5.

### FIG. 2

FIG. 2 shows a non-limiting example flowchart of a process 200 for applying a policy data structure to a new object, a new attribute of an existing object, and/or a change in an attribute of an existing object using the computer-implemented system of FIG. 1.

At operation 202, the process is triggered by one or more events that can be a manual event or an automatic event. Non-limiting example trigger events for evaluation using the policy tree data structure include the creation of a new model object, the addition of a new attribute to an existing model object, the modification of an attribute of an existing model object, new assessment information related to the policy and/or a model object, other types of external data that would make re-evaluation of policies applicable to various entities, and/or a periodic batch transaction for evaluating one or more systems, processes, products, etc. with respect to their adherence to one or more policies.

The triggering of process 200 may occur when a model object is received via policy applicator interface 104. When a model object is received via interface 104, policy applicator application 102 may process the received model object to determine whether the model object represents a new model object or whether a change is being effected to an existing model object. For example, an existing model object which has already been evaluated against the policy tree data structure may trigger the process when one or more attributes are changed. Model object information may be input to the policy applicator interface 104 either automatically or manually. In an example embodiment, the policy applicator interface 104 may interact with an information system such that whenever one or more predetermined objects in that information system changes, the process 200 is automatically triggered to evaluate the changed portion of the information system against the policy tree data structure.

Alternatively, the triggering may occur when a specification is received which affects and/or changes one or more of the nodes of the policy tree data structure, rule matrix or rules. For example, a risk classification rating change of one or more sections of a policy document may be required to be represented in the policy tree data stricture and/or rule matrix. According to another example, a chapter and/or section is added to a policy document, which results in the arrangement of nodes in the policy tree data structure being changed. According to yet another example, rules associated with a particular section is changed, thus causing changes to the rules matrix 108.

At operation 204, if found necessary due to the input received at operation 202, the policy tree data structure, rule matrix, rules, and/or one or more instances of model objects may be modified to be consistent with the received input. For example, if the input included a new or updated policy document, another policy tree data structure may be generated or an existing policy tree data structure may be modified (e.g., add or remove nodes, change parent-child relationship of nodes, change rule and/or policy associations of nodes, etc.), one or more rule-to-node mappings may be changed. A rule configuration change received as input may cause updates to the rules stored in the computer system. Moreover, program code, product specifications, pseudo code, and/or any other forms of input by which new model objects, or modified model objects are inputted to the policy applicator application, may cause the generation or modification of the corresponding model object in the memory accessible by the policy applicator application.

At operation 206, it is determined whether the policy at node 0 of the tree applies to the model object. The determination may include determining whether the policy document represented by node 0 (i.e., root node) of the policy tree data structure is applicable to the model object being evaluated. According to an example embodiment, node 0 includes an identification of the policy (e.g., policy document) represented by that node and that particular tree data structure, and a rule (which may be referred to as a policy rule) to determine if the policy represented by the tree data structure is applicable to a model object. The policy rule may specify one or more attributes that are required in model objects to which the represented policy is applicable. For example, the policy rule in the example embodiment shown in FIG. 4 specifies that any model object to which the policy of that example is applicable to must have either the layer attribute with a value “Application” or a region attribute with the value “United States”.

Other techniques of determining whether a policy document represented in a policy tree data structure is applicable to a model object are possible and are contemplated as embodiments. For example, the model objects may include one or more attributes identifying the policy documents known to be applicable to the entity or entities represented by that model object. Thus, in some example embodiments, the determination at operation 204 may be based upon whether the policy identified in node 0 corresponds to one or more of the applicable policies identified in the model object.

If it is determined that the policy does not apply to the model object, then process 200 ends. If it is determined that the policy applies, then through operations 208-214 the policy tree data structure is traversed. Operations 208-212 are performed for a plurality of nodes of the policy tree data structure, until it is determined at operation 214 that the traversal of the tree has been completed.

At operation 208, the next node against which the model object is to be evaluated is selected. The selection of the next node during the traversal of the tree can be based upon a depth-first, breadth-first, or other techniques of tree traversal. In some embodiments, these tree traversal techniques may be adapted specifically for the policy tree data structure by various techniques that leverage the unique features of the policy tree data structure. For example, while a given traversal technique may traverse all nodes of the tree in some predetermined order, in certain example embodiments, only those nodes that have associated requirements or obligations (e.g., the corresponding section in the policy document having at least one, or more than a predetermined number of, requirements and/or obligations) may be selected for evaluation against the model object. In some embodiments, only those nodes associated with rules having certain predetermined characteristics (e.g., nodes having at least one rule requiring a “high” risk classification for an entity) may be selected for evaluation.

At operation 210, a determination is made for respective nodes of the tree whether the particular node applies to the model object being evaluated.

Each of the nodes is associated with a one or more rules in the rule matrix for this policy tree. The associated rule(s) may include computer program scripts, program code, etc. Applying a model object node to a particular node in the policy tree data structure includes evaluating whether each of the rules associated with that particular node is satisfied by the model object. In some embodiments, the evaluating includes executing the associated rule(s) are on rule inputs, e.g., attribute information about the objects, to determine if this node is applicable to the object in the system. In the example embodiment described in relation to FIG. 4, a node is determined as applicable to a model object when the model object satisfies at least one of the rules associated with the node. More specifically, in that example embodiment, each rule requires one or more certain attribute values in the model object to match predetermined values. It will be understood, however, that the criteria for determining whether a node is applicable to a model object is configurable.

When the model object includes one or more other objects (e.g., higher level model object representing an information system and including child objects each representing a respective component of the information system) the evaluation against the node may include applying the higher level model object and, and in addition, applying none, one or more, or all of the child objects against the node. When the child objects themselves have other child objects, the node may be applied against these children of the child objects too.

While, in certain embodiments, each node may have one or more associated rules, in order for a model object to fully satisfy a node (i.e., so that the node is considered applicable to that model object) which has one or more child nodes, the model node may be required to traverse and evaluate against each of the child nodes. Accordingly, if a node has one or more child nodes which themselves have subtrees, whether the model object satisfies the parent node is determined may be based upon whether or not the model node successfully satisfies each of the child subtrees.

If a node is found not to be applicable to the model object, process 200 returns to operation 214 to determine whether traversal has completed, and if not, to select a new next node to be traversed. When a node is found to be applicable to a model object, at operation 212, one or more actions based upon the node and/or associated rules may be performed. One of the actions may be to store the result of the evaluation (e.g., that the section of the policy document corresponding to the node is applicable to the model object or part thereof). The actions may also include, for each node that is found to be applicable, storing in memory (e.g., as a report) a set of requirements and obligations specified in the corresponding section of the policy document, etc.

At operation 214, it is determined whether the traversal is complete. The determination may be based upon one or more factors or criteria, such as whether the model object has traversed all nodes of the tree data structure. Alternatively or additionally, in some embodiments, one or more other factors or criteria may be used. For example, in some embodiments, for improved efficiency, the traversal may be considered as complete when one or more particular nodes (e.g., nodes that are predetermined as higher priority or criticality) are found to be applicable to the model object. If the determination at operation 214 is negative, the traversal continues, and process 200 proceeds to operation 208 in order to select a next node.

In example embodiments, the tree includes a plurality of hierarchies, in which case, the evaluating operation of whether the determined one or more rules associated with the node applies to the model object includes performing the evaluating operation on a first one of the hierarchies followed by performing the evaluating operation on a second one of the hierarchies. In alternative example embodiments, the evaluating operation may include selecting the first one of the hierarchies and the second one of the hierarchies based upon one or more object attributes of the model object.

Returning to FIG. 2, if, at operation 214, it is determined that traversal is complete, then at operation 216, an action is performed. The action performed may be based upon one or all of the nodes that are found to be applicable to the model object. Non-limiting example actions may include performing some sort of assessment of the model object. Example model object assessments include a maturity assessment, an audit, a security test, an implementation test, determining if the model object complies with one or more requirements, etc. Another non-limiting example action includes updating one or more object attributes based on the assessment performed of the model object which can lead to applying different policies and/or different assessments. For example, in an embodiment described in relation to FIG. 4, the attribute corresponding to the entity's risk assessment (e.g., the business and/or security risk associated with the information system represented by a particular model object) may be updated after a traversal of an entire policy tree data structure is completed and an assessment is made in relation to the applicability of various policies to that model object. Yet another example action may be to generate a report based on the traversal and/or nodes found to be applicable. For example, a report may include each of the sections of the policy document determined to be applicable to the entity represented by the model object.

Although operations 202-216 are described as separate actions with a given order, this is done for ease of description. It should be understood that, in various embodiments, the above-mentioned actions may be performed in various orders; alternatively or additionally, portions of the above-described operations 202-216 may be interleaved and/or performed concurrently with portions of the other operations 202-216.

### FIG. 3

FIG. 3 shows a non-limiting example networked computer system for implementing the computer-implemented system and flowchart shown in FIGS. 1 and 2, respectively.

The server system 300 is configured to communicate with a client device 350 (e.g., via a network 340). It should be appreciated that the network 340 could comprise a network of interconnected computing devices, such as the Internet. The network 340 could also comprise a local area network (LAN) or could comprise a peer-to-peer connection between the server system 300 and client device 350. The server system 300 could comprise any variety of server devices including, but not limited to, database servers, file servers, web servers, application servers, a server cluster (e.g., a cloud based computing environment), a standalone server, and/or any other portable or stationary computing device having server-based capabilities.

The server system 300 can include a web server 304 that performs functionality such as implementing the HTTP protocol and communicating with the web browser application 311 (described in further detail below) in the client device 350 via HTTP. The server system 300 can also include an application server 305 that can, for example, execute server-side (or “back end”) instructions for applications that run on the server system 300. The server system 300 can also include a database 306 that manages the persistent storage of data that is used at the server system 300. The database 306 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system.

The client device 350 can include software components for performing processing related to web applications deployed in the server system 300. As a non-limiting example, the web browser 311 at the client device 350 may include, at least, a rendering module, a networking module and a JavaScript module. Of course, these modules are a non-limiting example, and the browser 311 can comprise several more modules and/or different modules than those noted. The client device 350 may comprise any variety of client devices including, but not limited to, a personal computer (e.g., a desktop computer, a laptop computer), a thin client, a hybrid client, a rich client, a game console, a tablet, a personal digital assistant (PDA), a smartphone, a digital music player having web interface capabilities, and/or any other portable or stationary computing device.

The server system 300 executes a policy applicator application 312. Policy applicator application 312 may include process 200, and operates in a manner similar to policy applicator application 102. The policy applicator application 312 may be executed on application server 305 and/or web server 304.

In some embodiments, policy applicator application 312 interacts with a client component on a client device. For example, policy applicator client 314, executing on client device 350, enables a user to perform web-based or app-based interaction with the policy applicator application 312 executing on the server 305. Policy applicator client 314 may provide a user-interface for configuring and/or using the policy applicator application 312. In some embodiments, electronic files of policy documents may be uploaded to the policy applicator application 312 from a remote computer via policy applicator client 314. The policy applicator application 312 may create or update a policy tree data structure based upon the uploaded policy document. In some embodiments, model objects or electronic files of code may be uploaded to the policy applicator application 312 via client 314 for evaluation against the policy tree data structure(s) at the server computer system 300.

It should be appreciated that while the diagram in FIG. 3 shows the components existing within a single system, the components could be incorporated in multiple systems and/or a distributed computing environment (e.g., a cloud computing environment). Thus, the processing system 200 is not limited to a single component and can be incorporated into multiple components.

### FIG. 4—A Specific Example

FIG. 4 is a block diagram of a non-limiting detailed example of policy applicator application 102 adapted to apply an information technology (IT) policy tree data structure and associated rules to new model objects corresponding to different types of software code. The new model objects are processed to determine if a NIST (National Institute of Standards and Technology) Cyber Security Framework policy applies to any of those new model objects. The new model objects include an application BW at a database layer (object identifier 002), an ECC Kernel 6.0 application at an application layer (object identifier 003), and a BWSCMDEV application at an operating system layer (object identifier 004).

The policy tree data structure 406 is hierarchical and includes multiple layers (e.g., levels) of nodes. At the first or top layer, there is the policy tree data structure root node 414 that is mapped to the NIST Cyber Security Framework policy document. That document, in this simplified example, includes two chapters titled Access Controls (AC) and Access and Training (AT) mapped to two child nodes at the second layer of the hierarchical tree data structure. One child node is labeled Access Controls (AC) and has a node identifier AC, and the other child node in the second layer of the tree is labeled Access and Training (AT) and has a node identifier AT. The description focuses on node AC and the subtree nodes in lower levels in the hierarchy.

Two child nodes having identifiers AC-1 and AC-2 are highlighted as examples in the rule matrix 408. Node AC-1 is mapped with Access Control Policy and Procedures (a sub-chapter or topic under Access Controls in the NIST Cyber Security Framework policy document). Node AC-2 is mapped with Account Management (another sub-chapter or topic under Access Controls in the NIST Cyber Security Framework policy document). Node AC-1 is associated with rules Low, Medium, and High. Node AC-2 is associated with rules Low, Medium, and High.

Under Node AC-2 are nodes AC2(1)-(5) at the next layer down in the hierarchy. Node AC2(1) is mapped to the AC topic titled Automated System Account Management and is associated with rules Medium and High. Node AC2(2) is mapped to the AC topic titled Removal of Temporary Emergency Accounts and is associated with rules Medium and High. Node AC2(3) is mapped to the AC topic titled Disable Inactive Accounts and is associated with rules Medium and High. Node AC2(4) is mapped to the AC topic titled Automated Audit Action and is associated with rules Medium and High. Node AC2(5) is mapped to the AC topic titled Inactivity Logout and is associated with rule High.

Rules 410 include the computer instructions for a Policy Rule, High, Medium and Low.

The overall policy rule includes filter-type code or scripts that determines if the NIST Cyber Security Framework policy tree data structure is applicable to any of the model objects 001-003. The example Policy Rule “bw.filter(getAISASC, ‘e.layer==“Application”) OR bw.filter(getAE, ‘e.region==“United States”’)”, upon being applied to a model object, evaluates only model objects having a layer attribute as “Application” or a region attribute as “United States” as having the NIST policy of the policy tree data structure 406 being applicable. Because object 003 incudes a layer attribute having a value “Application”, the first part in the policy rule applies to object 003, and the Policy Rule (e.g., the rule applied to any model node at the root node at the beginning of traversing the policy tree data structure) is determined to apply to object 003. Then, the computer system using a process such as process 200 shown in FIG. 2 traverses the nodes in the NIST Cyber Security Framework policy tree data structure 406 to determine which nodes apply to the object 003.

The traversing of the policy tree data structure may be performed using any tree data structure traversing techniques such as depth-first search, breadth-first search etc., or combinations thereof. During traversing the policy tree data structure for object 003 (see operation 202 in FIG. 2), at each node, the rules associated with that node are identified and applied to object 003. For example, at node AC, the computer system determines that the rule matrix does not associate any rules with the node, and therefore, node AC may be considered to apply to any model object regardless of the classification of the model object (see “Yes” result of operation 206 in FIG. 2).

When traversing node AC-1 (see operation 208 in FIG. 2), the rule matrix identifies rules High, Medium, and Low all being associated with the node. Rule High, specified as “if (bw.filter(this.getLOA, “e.type==“EA””).answer(“EntityRisk”)==“High’) {true;} else {false;}” determines whether the last assessment of the entity represented by the object being evaluated was found to have a “high” entity risk. The entity risk attribute in object 003 (e.g., “LastBIAResult” attribute) specifies “High”. Therefore, at node AC-1 the rule High evaluates to true for object 003. However, because the entity risk attribute in object 003 specifies “High”, rule Low from rules 410, which specifies “if (bw.filter(this.getLOA, “e.type==“EA””).answer(“EntityRisk”)==“Low”) {true;} else {false;}” evaluates to false for object 003. Similarly, rule Medium is also found to evaluate as false for object 002 at node AC-1. With respect to node AC-1, because at least one associated rule is found to apply to object 003, node AC-1 may be considered applicable to object 003 (see “Yes” result of operation 210 in FIG. 2). That is, at least in some embodiments, the policies associated with node AC-1, which may be the policies in or related to the chapter or section titled “Access Control Policy and Procedures” in the NIST Cybersecurity Framework policy document are determined as applicable to the entity represented by model object 003.

In some embodiments, a node may be considered applicable to a particular model object only if all the rules associated with that node evaluate to true for that object. In yet other embodiments, a predetermined portion or minimum number of the associated rules may be required to successfully evaluate to true for a particular model object before that node is determined as applicable to that particular object.

When model object 002 begins traversing policy tree data structure 406 (operation 202 in FIG. 2), it evaluates to true with respect to rule Policy Rule of the root node 414 because, although its layer attribute does not have the value required by the rule, its region attribute is set to value United States as required by the rule. Having found the policy as being applicable to it (see “Yes” result of operation 206 in FIG. 2), model object 002 may now traverse the rest of the tree data structure. As one example, model object 002 would also be evaluated against node AC-1 and be found applicable because node AC-1 is associated with rule Low and the entity risk attribute in object 002 is set to Low (see “Yes” result of operation 210 in FIG. 2). On the other hand, model object 002 would not be found applicable to node AC-2(1) (see “No” result of operation 210 in FIG. 2) because that node is not associated with rule Low according to the rule matrix, and the entity risk attribute in object 002 is set to Low.

In contrast to model objects 002 and 003, when object 004 begins traversing policy tree data structure 406 (see operation 202 in FIG. 2), it evaluates to false with respect to rule Policy Rule of the root node 414 because neither its layer attribute nor its region attribute matches the filter criteria of the policy rule of the root node. Thus, model object 004 will not traverse the rest of the tree date structure (see “No” result of operation 206 in FIG. 2). In effect, this means that the entity represented by model object 004 is not required to comply with the requirements of the policy document represented in the tree data structure 406.

### FIG. 5

FIG. 5 is a block diagram of an exemplary computer system 500 according to certain example embodiments. Computer system 500 includes a processing system 502 with CPU 1, CPU 2, CPU 3, CPU 4, a system bus 504 that communicates with RAM 506 (which may also be referred to as a “memory”), and storage 508. The storage 508 can be magnetic, flash based, solid state, or other storage technology. The system bus 504 communicates with user input adapter 510 (e.g., PS/2, USB interface, or the like) that allows users in input commands to computer system 500 via a user input device 512 (e.g., a keyboard, mouse, touch panel, or the like). The results of the processing may be displayed to a user on a display 516 (e.g., an LCD) via display interface 514 (e.g., a video card or the like).

The computer system 500 may also include a network interface 518 (e.g., a transceiver) to facilitate wired (e.g., Ethernet—802.3x) and/or wireless communication (WiFi/802.11x protocols, cellular technology, and the like) with external systems, databases, and other systems via a network. Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

External systems may include other processing systems, systems that provide third party services, etc. External systems may be client devices or server systems.

External systems may also include network attached storage (NAS) to hold large amounts of data. External systems, along with the internal storage and memory, may form a storage system for storing and maintaining information The database may include relational, object orientated, or other types of databases for storing information (e.g., order book information for a financial instrument).

The computer system may be arranged, in various embodiments, in many different ways. As just one example, the computing system may be arranged such that processors include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip or a “system-on-chip”). As another example, the computing system may be arranged such that: the processors include two, three, four, five, or more multi-core processors; the network interface devices include a first network interface device that implements Ethernet and a second network interface device that implements WiFi and/or Bluetooth; and the memory devices include a RAM and a flash memory or hard disk.

In other words, the processes, techniques, and the like, described herein (for client devices, server, exchange, and/or controller systems) may be implemented on a computer system. Such implementations may then configure or program the processing system to carry out aspects according to certain example embodiments. It will be appreciated that other architecture types may be used. For example, a single CPU may be used instead of multiple CPUS. Alternatively, a processing system may include multiple CPU “cores.” Further, the various elements shown in connection with FIG. 5 may be included into one cohesive physical structure (e.g., such as a tablet device). The components and functionality shown in FIGS. 1-4 may be implemented on or in conjunction with the example computer system shown in FIG. 5 (e.g., to thereby create a specific purpose machine). As described herein when a software module or software process performs any action, the action is performed by underlying hardware elements according to the instructions that comprise the software module. In various embodiments, each or any combination of the computer system 100, policy applicator application 102, policy applicator interface 104, policy tree data structure 106, rule matrix 108, rules 110, model objects 110, process 200, server computer system 300, client device 350, web server 304, application server 305, database 306, web browser 311, policy applicator application 312, policy applicator client 314, and policy applicator application 402, etc., each of which will be referred to individually for clarity as a “component” for the remainder of this paragraph, are implemented using an example of the computing system 500 of FIG. 5.

In such embodiments, the following applies for each component: (a) the elements of the 500 computing system 500 shown in FIG. 5 (i.e., the one or more processors 502, one or more memory devices 506 or 508, one or more network interface devices 518, one or more display interfaces 514, and one or more user input adapters 510), or appropriate combinations or subsets of the foregoing) are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the memory devices 506 and/or 508 (e.g., in various embodiments, in a volatile memory device such as a RAM, in an instruction register, and/or in a non-volatile memory device such as a flash memory or hard disk) and all actions described herein as performed by the software modules are performed by the processors 502 in conjunction with, as appropriate, the other elements in and/or connected to the computing system 500 (i.e., the network interface devices 518, display interfaces 514, user input adapters 510, and/or display device 516); (c) alternatively or additionally, to the extent it is described herein that the component processes and/or otherwise handles data, in some embodiments, such data is stored in the memory devices (e.g., in some embodiments, in a volatile memory device such as a RAM and/or in a non-volatile memory device such as a flash memory or hard disk) and/or is processed/handled by the processors 502 in conjunction, as appropriate, the other elements in and/or connected to the computing system 500 (e.g., the network interface devices 518, display interfaces 508, user input adapters 510, and/or display device 516); (d) alternatively or additionally, in some embodiments, memory devices store instructions that, when executed by the processors 502, cause the processors 502 to perform, in conjunction with, as appropriate, the other elements in and/or connected to the computing system 500, each or any combination of actions described herein as performed by the component and/or by any software modules described herein as included within the component.

### Technical Advantages of Described Subject Matter

In certain example embodiments, the subject matter described improves the efficiency by which compliance levels of various systems, processes, products and other entities with respect to various requirements and obligations are determined by computer systems. By improving that efficiency, and in providing for automatically determining the level of compliance in systems that may dynamically change configurations, example embodiments may also improve the security, robustness, etc. of those systems. For example, when an information system configuration is changed by a developer or user, automatically triggering a process for determining compliance of that system with various requirements and obligations may automatically and dynamically alert the developer or user of any deficiencies with the just-affected changes, and may, in some cases, automatically cause rectification of the deficiencies.

Embodiments enable automatically determining the compliance of multiple objects representing various entities with respect to multiple policy documents. As systems, products, etc., become more complex and also as policy requirements become numerous and more complex, embodiments provide the capability to perform compliance determination of individual entities and also of aggregations of entities.

### Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. A computer system for implementing an in-memory, hierarchical data structure, comprising:
an interface configured to receive electronic input corresponding to a document that defines a set of requirements;
a memory configured to store:
an in-memory tree data structure having a set of nodes linked as a hierarchy, where a highest level node in the hierarchy is mapped to the document and other nodes at multiple lower levels in the hierarchy are mapped to parts of the document corresponding to different constraints in the set of requirements;
a set of conditional rules, each rule being associated with a rule identifier;
a rule matrix that indicates a mapping of nodes in the set of nodes to associated rules in the set of conditional rules; and
the interface being further configured to receive electronic data corresponding to an event associated with a model object, the model object having an object identifier and object attributes; and
a processing system that includes at least one computer processor coupled to the memory and the interface, the processing system configured to perform operations that include:
for each node of a plurality of nodes in the hierarchy of the in-memory tree data structure:
accessing the rule matrix to determine one or more rules associated with the node;
evaluating whether the determined one or more rules associated with the node applies to the model object; and
when one or more rules associated with the node apply to the model object, performing a corresponding action for the model object.

2. The computer system in claim 1, wherein:
each of the nodes in the set of nodes has a node identifier;
each of the rules has a rule identifier;
the rule matrix includes mapping pairs, each mapping pair having one of the node identifiers mapped to one of the rule identifiers; and
the evaluating whether the determined one or more rules associated with the node applies to the model object includes comparing the node's identifier with the node identifiers in the rule matrix to detect one of the mapping pair that matches the node's identifier.

3. The computer system in claim 1, wherein the operations further include:
for each node of the plurality of nodes in the hierarchy of the in-memory tree data structure, determining that one or more rules associated with the node applies to the model object; and
for each node of the plurality of nodes in the hierarchy of the in-memory tree data structure, determining if traversal of the in-memory tree data structure is complete based on one or more factors.

4. The computer system in claim 3, wherein the one or more factors for determining if traversal of the in-memory tree data structure is complete include whether one or more higher priority nodes of the in-memory tree data structure is found to be applicable to the model object.

5. The computer system in claim 3, wherein the operations further include:
for each node of the plurality of nodes in the hierarchy of the in-memory tree data structure, determining if the model object complies with one or more requirements.

6. The computer system in claim 3, wherein the operations further include:
performing an assessment on the model object; and
updating one or more object attributes of the model object based on the assessment.

7. The computer system in claim 6, wherein the operations further include:
for each node of the plurality of nodes in the hierarchy of the in-memory tree data structure, repeatedly evaluating whether one or more rules associated with the node applies to the updated model object.

8. The computer system in claim 1, wherein the operations further include:
repeatedly evaluating whether one or more rules associated with another node of the plurality of nodes applies to the updated model object.

9. The computer system in claim 1, wherein the operations further include:
generating one or more reports for one or more levels or nodes in the hierarchy of the in-memory data structure.

10. The computer system in claim 1, wherein when the operations further include:
filtering a report generated for one or more levels or nodes in the hierarchy of the in-memory data structure.

11. The computer system in claim 1, wherein:
the one or more rules is defined as a script; and
for each node of the plurality of nodes in the hierarchy of the in-memory tree data structure, the evaluating of whether the determined one or more rules associated with the node applies to the model object includes executing the script using at least some of the received electronic input and using one or more attributes of the model object.

12. The computer system in claim 1, wherein the event associated with the model object indicates that the model object is new or indicates a modification of an attribute of the model object.

13. The computer system in claim 1, wherein the event indicates a change of one or more of the set of nodes, and wherein the change includes a change of at least one rule associated with a node of the hierarchy or a change of an arrangement of nodes in the hierarchy.

14. The computer system in claim 1, wherein the set of nodes are arranged as a plurality of hierarchies, and wherein the evaluating operation of whether the determined one or more rules associated with the node applies to the model object includes performing the evaluating operation on a first one of the hierarchies followed by performing the evaluating operation on a second one of the hierarchies.

15. The computer system in claim 14, wherein the evaluating operation of whether the determined one or more rules associated with the node applies to the model object further includes selecting the first one of the hierarchies and the second one of the hierarchies based upon one or more object attributes of the model object.

16. The computer system in claim 1, wherein the object attributes of the model object include one or more evaluation categories and an assigned rating for each of the evaluation categories, wherein each node in the set of nodes includes at least one rule with an applicable rating for one or more said evaluation categories, and wherein the evaluation includes determining whether the assigned ratings of the model object corresponds to the applicable ratings of the at least one rule.

17. A method, comprising:
receiving at an interface associated with a computer processor electronic input corresponding to a document that defines a set of requirements;
storing in a memory associated with the computer processor a data structure having a set of nodes linked as a hierarchy, where a highest level node in the hierarchy is mapped to the document and other nodes at multiple lower levels in the hierarchy are mapped to parts of the document corresponding to different constraints in the set of requirements;
storing in the memory (i) a set of conditional rules, each rule being associated with a rule identifier, and (ii) a rule matrix mapping nodes to associated rules;
receiving at the interface electronic data corresponding to an event to add a model object, the model object having an object identifier and object attributes;
accessing by the computer processor the rule matrix to determine one or more rules associated with the node;
evaluating whether the determined one or more rules associated with the node applies to the object accessing; and
when one or more rules associated with the node apply to the model object, the computer processor performing a corresponding action for the object.

18. A non-transitory computer-readable storage medium storing computer programming instructions which, when executed by a computer processor, causes the computer processor to perform operations comprising:
receiving at an interface associated with the computer processor electronic input corresponding to a document that defines a set of requirements;
storing in a memory associated with the computer processor a data structure having a set of nodes linked as a hierarchy, where a highest level node in the hierarchy is mapped to the document and other nodes at multiple lower levels in the hierarchy are mapped to parts of the document corresponding to different constraints in the set of requirements;
storing in a memory (i) a set of conditional rules, each rule being associated with a rule identifier, and (ii) a rule matrix mapping nodes to associated rules;
receiving at the interface electronic data corresponding to an event to add a model object, the model object having an object identifier and object attributes; and
accessing by the computer processor the rule matrix to determine one or more rules associated with the node;
evaluating whether the determined one or more rules associated with the node applies to the object accessing; and
when one or more rules associated with the node apply to the model object, the computer processor performing a corresponding action for the object.
